(19) United States
(12) Patent Application Publication
(10) Pub. No.: US 2026/0268780 A1
(43) Pub. Date: Sep. 10, 2026

(54) AERIAL VEHICLE DIVERSION PREDICTION BASED ON OPERATIONAL DATA

(71) Applicant: International Business Machines Corporation, Armonk, NY (US)

(72) Inventors: Andrew Thomas Penrose, Castleknock (IE); Jonathan David Dunne, Dungarvan (IE); James Christopher Dorsey, Chelmsford, MA (US); John O'Connor, Middleton, MA (US)

(21) Appl. No.: 19/071,325

(22) Filed: Mar. 5, 2025

(51) Int. Cl. G08G 5/38; G08G 5/34

(52) U.S. Cl. CPC G08G 5/38; G08G 5/34

(57) ABSTRACT

Aerial vehicle diversion prediction based on operational data is provided. Aerial vehicle diversion prediction includes retrieving operation data. The operation data includes historical operation data and current operation data. A deviance score for each of a set of diversion parameters is generated based on an application of a first model to the historical operation data. A subset of diversion parameters from the set of diversion parameters is determined based on the deviance score. A second model is generated for each diversion parameter of the subset of diversion parameters. Probability data is determined for each diversion parameter of the subset of diversion parameters based on the second model for each diversion parameter. Diversion data is generated for the diversion of the aerial vehicle from the destination. The diversion data is output based on the determination.

### BACKGROUND

The disclosure relates to prediction of diversion of aerial vehicles.

Airline operations are sensitive to unpredictable weather conditions. The weather conditions impact flight safety, scheduling, and overall efficiency of airline operations. Flight diversions are a significant challenge in the aviation industry, often arising due to adverse weather conditions such as poor visibility, strong crosswinds, or lightning activity. Flight diversions not only disrupt passenger travel plans but also lead to operational inefficiencies, increased fuel consumption, and additional costs for airlines. Moreover, the logistical complexity of rerouting flights and reallocating resources further strains airline operations, making diversions a demanding issue requiring effective management strategies.

### SUMMARY

In various embodiments of the disclosure, a computer-implemented method for aerial vehicle diversion prediction based on operational data is described. The computer-implemented method includes retrieving, by a computer, operation data associated with an aerial vehicle. The operation data includes historical operation data and current operation data. The historical operation data is associated with a destination of the aerial vehicle and the current operation data is associated with an operation of the aerial vehicle. The computer-implemented method further includes applying, by the computer, a first model to the historical operation data. The computer-implemented method further includes generating, by the computer, a deviance score for each diversion parameter of a set of diversion parameters based on the application of the first mode. Each diversion parameter of the set of diversion parameters is associated with diversion of the aerial vehicle from the destination. The computer-implemented method further includes determining, by the computer, a subset of diversion parameters from the set of parameters based on the deviance score. The computer-implemented method further includes generating, by the computer, a second model for each diversion parameter of the subset of diversion parameters. The second model is generated based on the current operation data. The computer-implemented method further includes determining, by the computer, probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. The computer-implemented method further includes generating, by the computer, diversion data for the diversion of the aerial vehicle. The diversion data is generated based on the probability data. The computer-implemented method further includes outputting, by the computer, the diversion data.

In various embodiments of the disclosure, a computer system for aerial vehicle diversion prediction based on operational data is described.

In various embodiments of the disclosure, a computer-program product for aerial vehicle diversion prediction based on operational data is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for prediction of aerial vehicle diversion, in accordance with an embodiment of the disclosure;

FIG. 2 is a diagram that illustrates an environment for the prediction of aerial vehicle diversion based on operational data, in accordance with an embodiment of the disclosure;

FIG. 3 is a block diagram that illustrates exemplary operations for the prediction of aerial vehicle diversion, in accordance with an embodiment of the disclosure;

FIG. 4A is a block diagram that illustrates exemplary operations for determining a subset of diversion parameters for predicting aerial vehicle diversion, in accordance with an embodiment of the disclosure;

FIG. 4B is a block diagram that illustrates exemplary operations for generating diversion data for predicting aerial vehicle diversion, in accordance with an embodiment of the disclosure;

FIG. 5 is a diagram that illustrates exemplary operations for determining probability data for predicting aerial vehicle diversion, in accordance with an embodiment of the disclosure;

FIG. 6 is a block diagram that illustrates exemplary operations for updating diversion data, in accordance with an embodiment of the disclosure;

FIG. 7 is a diagram that illustrates an exemplary user interface for displaying diversion data for aerial vehicle diversion, in accordance with an embodiment of the disclosure; and

FIG. 8 is a flow chart that illustrates an exemplary method for the prediction of aerial vehicle diversion, in accordance with an embodiment of the disclosure.

### DETAILED DESCRIPTION

The airline industry, which is significant to global connectivity, suffers operational issues, such as flight delays, increased cost of operation, increased cost of maintenance, and customer dissatisfaction due to flight diversions. Flight diversions are frequently a result of circumstances such as bad weather, technical problems, air traffic congestion, and crises. These diversions result in significant economic losses, delays to airline operations, and inconvenience for passengers. Flight diversions not only affect airline operations but also cause financial losses.

Traditional methods for predicting flight diversions are primarily reliant on rule-based systems, which have limited adaptability for different flight types and different destination locations (e.g., countries, or cities) and precision in predicting diversion. The traditional methods fail to account for the interrelated variables that influence flight diversions. As a result, the aviation sector demands innovative systems that can use machine learning and artificial intelligence to make accurate and timely predictions about flight diversions.

The growing complexity of flight operations highlights the importance of reliable prediction systems for accurately analyzing varied information and recognizing patterns that influence flight diversions. As the demand for air travel rises, it is significant to create innovative methods for improving the decision-making and operating efficiency of flights in real-time. This is especially true in situations when unplanned diversions might lead to fuel wastage, safety hazards, or logistical issues.

Traditional methods for diversion prediction often rely on radar data and image processing techniques and do not adequately address the need for real-time analysis and the integration of diverse data sources. One of the key challenges in predicting flight diversions is the dynamic nature of the contributing factors. These factors include, but are not limited to, environmental conditions (e.g. weather and turbulence), operational constraints (e.g. fuel levels and aviation traffic), and sudden events (e.g. emergencies, illness, flight malfunction, etc.). Traditional predictive models are ineffective at processing the contribution of each of these contributing factors for flight diversion in real-time.

To address the aforementioned problems, the present disclosure provides a method and a system for the prediction of flight diversion based on various factors in real-time. The flight diversion prediction is performed by using advanced machine learning (ML) and artificial intelligence (AI) processes. In particular, the present disclosure predicts a probability of flight diversion, for example, a probability of a flight being diverted, based on weather conditions in real-time. In this regard, the system of the present disclosure is configured to predict a probability score for flight diversions in real-time based on each contributing environmental factor. Thereafter, a probability of diversion is predicted based on an analysis of each of the probability scores.

The prediction of the flight diversion in real-time enables stakeholders (such as pilots, flight crew, flight ground staff, etc.) to determine the risks of being diverted to a different destination from an intended destination while a flight is in transit, and adequately prepare for the risks. In certain cases, timely prediction of a high probability of diversion for a flight may reduce costs associated with the operation of the flight, avoid any safety hazards in flight operation, and ensure overall improved customer satisfaction. Moreover, the timely prediction of the high probability of diversion for the flight may enable planning of flight operations, specifically, in areas having adverse weather conditions, as well as better logistical planning, such as related to handling traffic of the diverted flight and moving of people of the diverted flight to their intended destination.

The system of the present disclosure provides various technical advantages that overcome the limitations of conventional flight diversion prediction systems. Unlike traditional systems that rely on monolithic models with high computational complexity, the disclosed system employs a combination of a logistic regression model for feature determination and a Hidden Markov Model (HMM) for sequence analysis.

One key technical advantage of the disclosed system is the reduction in computational load and complexity through the focused generation and analysis of HMMs for each subset of diversion parameters of the set of diversion parameters. By isolating and analyzing only a set of diversion parameters pertinent to a particular flight, the disclosed system minimizes unnecessary computations, ensures faster real-time processing, and provides accurate predictions without requiring extensive computing resources.

Furthermore, the embodiments of the present disclosure improve prediction accuracy by mitigating the impact of irrelevant data and reducing noise. The logistic regression model identifies key features associated with flight diversions, such as weather conditions and fuel status, while the HMM models temporal dependencies among the key features. This selective analysis reduces the likelihood of overfitting and ensures that the flight diversion prediction remains robust across diverse flight scenarios. As a result, the flight diversion predictions are dependable and consistent.

Furthermore, the disclosed system also provides adaptation to temporal patterns. The HMM's ability to capture sequential and time-dependent relationships ensures that the system can adapt to evolving conditions, such as seasonal weather changes or fluctuating air traffic patterns. This continuous adaptation enhances the long-term accuracy and reliability of the system.

In various embodiments of the disclosure, a computer-implemented method for aerial vehicle diversion prediction based on operational data is described. The computer-implemented method includes retrieving, by a computer, operation data associated with an aerial vehicle. The operation data includes historical operation data and current operation data. The historical operation data is associated with a destination of the aerial vehicle and the current operation data is associated with an operation of the aerial vehicle. The computer-implemented method further includes applying, by the computer, a first model to the historical operation data. The computer-implemented method further includes generating, by the computer, a deviance score for each diversion parameter of a set of diversion parameters based on the application of the first mode. Each diversion parameter of the set of diversion parameters is associated with the diversion of the aerial vehicle from the destination. The computer-implemented method further includes determining, by the computer, a subset of diversion parameters from the set of parameters based on the deviance score. The computer-implemented method further includes generating, by the computer, a second model for each diversion parameter of the subset of diversion parameters. The second model is generated based on the current operation data. The computer-implemented method further includes determining, by the computer, probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. The computer-implemented method further includes generating, by the computer, diversion data for the diversion of the aerial vehicle. The diversion data is generated based on the probability data. The computer-implemented method further includes outputting, by the computer, the diversion data.

In various embodiments of the disclosure, the historical operation data includes at least one of historical flight operations records, historical weather condition data, historical air traffic pattern data, or historical flight schedule data.

In various embodiments of the disclosure of the embodiments, the current operation data includes at least one of real-time flight data associated with the aerial vehicle, real-time weather data associated with the destination, real-time air traffic data, or real-time runway condition data associated with the destination.

In various embodiments of the disclosure, the set of diversion parameters is associated with at least one of wind speed, wind direction, gust speed, visibility, or occurrence of lightning.

In various embodiments of the disclosure, the computer-implemented method further includes generating, by the computer, ranking data for each diversion parameter of the set of diversion parameters based on the deviance score. The computer-implemented method further includes identifying, by the computer, the subset of diversion parameters from the set of parameters based on the ranking data.

In various embodiments of the disclosure, to generate the second model for a specific diversion parameter of the subset of diversion parameters, the computer-implemented method further includes retrieving, by the computer, attribute data associated with each attribute of a plurality of attributes. The plurality of attributes is associated with the specific diversion parameter of the subset of diversion parameters. The computer-implemented method further includes specifying, by the computer, a plurality of states of the second model associated with the specific diversion parameter based on the attribute data. Each state of the plurality of states corresponds to an attribute of the plurality of attributes. The computer-implemented method further includes specifying a pair of output states of the second model. The computer-implemented method further includes generating, by the computer, a set of transition probabilities between the plurality of states. Each transition probability of the set of transition probabilities corresponds to a likelihood of transition of a first state of the plurality of states to a second state of the plurality of states. The computer-implemented method further includes generating, by the computer, a set of emission probabilities for the specific diversion parameter based on the set of transition probabilities. Each emission probability of the set of emission probabilities indicates a likelihood of output of one of the pair of output states given a state of the plurality of states.

The computer-implemented method further includes determining, by the computer, a probability distribution over the plurality of states of the second model. The computer-implemented method further includes determining, by the computer, the probability data associated with the specific diversion parameter based on the probability distribution. The probability data indicates a first probability of a first output state of the pair of output states and a second probability of a second output state of the pair of output states.

In various embodiments of the disclosure, the first output state is associated with the diversion of the aerial vehicle from the destination, and the second output state is associated with a landing of the aerial vehicle at the destination.

In various embodiments of the disclosure, the computer-implemented method further includes determining, by the computer, crosswind data associated with the destination. The crosswind data is determined based on the historical operation data. The historical operation data indicates one or more historical occurrences of each output state of the pair of output states. The computer-implemented method further includes generating, by the computer, the set of emission probabilities for the specific diversion parameter based on the crosswind data.

In various embodiments of the disclosure, the first model corresponds to a regression model and the second model corresponds to a Hidden Markov Model (HMM).

In various embodiments of the disclosure, the computer-implemented method further includes receiving, by the computer, updated current operation data. The computer-implemented method further includes updating, by the computer, the probability data for each diversion parameter of the subset of diversion parameters based on the updated current operation data. The computer-implemented method further includes updating, by the computer, the diversion data for the diversion of the aerial vehicle from the destination. The diversion data is updated based on the updated probability data.

In various embodiments of the disclosure, a computer system for aerial vehicle diversion prediction based on operational data is described. The computer system includes a processor set, one or more computer-readable storage media, and program instructions stored on the one or more computer-readable storage media. The program instructions executable by the processor set causes the processor set to retrieve operation data associated with an aerial vehicle. The operation data includes historical operation data and current operation data. The historical operation data is associated with a destination of the aerial vehicle and the current operation data is associated with an operation of the aerial vehicle. The program instructions cause the processor set to apply a first model to the historical operation data. The program instructions cause the processor set to generate a deviance score for each diversion parameter of a set of diversion parameters based on the application of the first model. Each diversion parameter of the set of diversion parameters is associated with a diversion of the aerial vehicle from the destination. The program instructions cause the processor set to determine a subset of diversion parameters from the set of diversion parameters based on the deviance score. The program instructions cause the processor set to generate a second model for each diversion parameter of the subset of diversion parameters. The second model is generated based on the current operation data. The program instructions cause the processor set to determine probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. The program instructions cause the processor set to generate diversion data for the diversion of the aerial vehicle from the destination. The diversion data is generated based on the probability data. The program instructions cause the processor set to output the diversion data.

In various embodiments of the disclosure, the program instructions cause the processor set to generate ranking data for each diversion parameter of the set of diversion parameters based on the deviance score. The program instructions further cause the processor set to identify the subset of diversion parameters from the set of diversion parameters based on the ranking data.

In various embodiments of the disclosure, to generate the second model for a specific diversion parameter of the subset of diversion parameters, the program instructions cause the processor set to retrieve attribute data associated with each attribute of a plurality of attributes, wherein the plurality of attributes is associated with the specific diversion parameter of the subset of diversion parameters. The program instructions cause the processor set to specify a plurality of states of the second model associated with the specific diversion parameter based on the attribute data. Each state of the plurality of states corresponds to an attribute of the plurality of attributes. The program instructions cause the processor set to specify a pair of output states of the second model. The program instructions cause the processor set to generate a set of transition probabilities between the plurality of states. Each transition probability of the set of transition probabilities corresponds to a likelihood of transition of a first state of the plurality of states to a second state of the plurality of states. The program instructions cause the processor set to determine crosswind data associated with the destination. The crosswind data is determined based on the historical operation data. The historical operation data indicates one or more historical occurrences of each output state of the pair of output states. The program instructions cause the processor set to generate a set of emission probabilities for the specific diversion parameter based on the set of transition probabilities and the crosswind data. Each emission probability of the set of emission probabilities indicates a likelihood of output of one of the pair of output states given a state of the plurality of states.

The program instructions cause the processor set to determine a probability distribution over the plurality of states of the second model. The program instructions cause the processor set to determine the probability data associated with the specific diversion parameter based on the probability distribution. The probability data indicates a first probability of a first output state of the pair of output states and a second probability of a second output state of the pair of output states.

In various embodiments of the disclosure, the first output state is associated with the diversion of the aerial vehicle from the destination, and the second output state is associated with a landing of the aerial vehicle at the destination.

In various embodiments of the disclosure, a computer-program product for aerial vehicle diversion prediction is described. The computer program product includes a computer-readable storage medium having program instructions embodied therewith, the program instructions executable by a system to cause the system to retrieve operation data associated with an aerial vehicle. The operation data includes historical operation data and current operation data. The historical operation data is associated with a destination of the aerial vehicle and the current operation data is associated with an operation of the aerial vehicle. The program instructions further include applying a first model to the historical operation data. The program instructions further include generating a deviance score for each diversion parameter of a set of diversion parameters based on the application of the first model. Each diversion parameter of the set of diversion parameters is associated with the diversion of the aerial vehicle from the destination. The program instructions further include determining a subset of diversion parameters from the set of diversion parameters based on the deviance score. The program instructions further include generating a second model for each diversion parameter of the subset of diversion parameters. The second model is generated based on the current operation data. The program instructions further include determining probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. The program instructions further include generating diversion data for the diversion of the aerial vehicle from the destination. The diversion data is generated based on the probability data. The program instructions further include outputting the diversion data.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or any transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

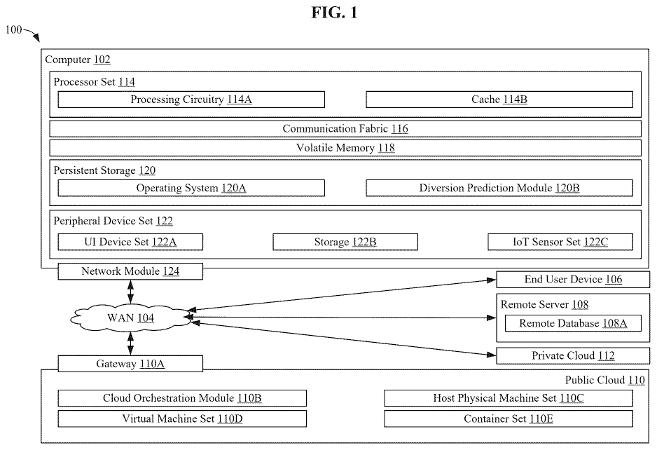

FIG. 1 is a diagram that illustrates a computing environment for prediction of aerial vehicle diversion, in accordance with various embodiments of the disclosure. With reference to FIG. 1, there is shown a computing environment 100 that contains an example of an environment for the execution of at least some of the computer code involved in performing the disclosed methods, such as a diversion prediction module 120B. In addition to the diversion prediction module 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the diversion prediction module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is proficient of running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not needed to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the diversion prediction module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the diversion prediction module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) proficient in communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

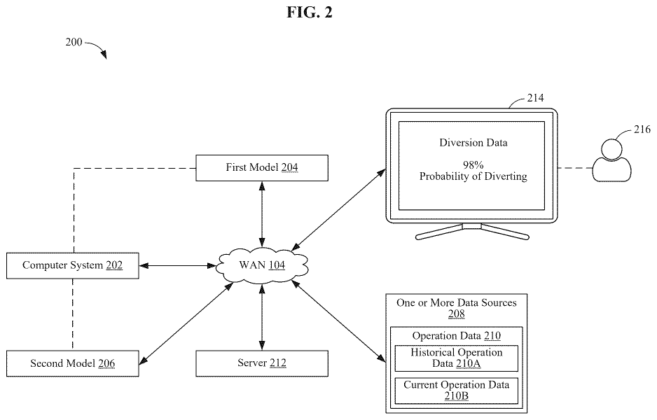

FIG. 2 is a diagram that illustrates an environment for the prediction of aerial vehicle diversion based on operation data, in accordance with various embodiments of the disclosure. FIG. 2 is explained in conjunction with elements of FIG. 1. With reference to FIG. 2, there is shown a diagram of a network environment 200. The network environment 200 includes a computer system 202 (referred to as the system 202, hereinafter), a first model 204, a second model 206, one or more data sources 208, a server 212, and a user device 214. The one or more data sources 208 include operation data 210. In an example, the operational data 210 includes historical operation data 210A and current operation data 210B. The user device 214 is associated with a user 216. The network environment 200 further includes the WAN 104 of FIG. 1. In various embodiments of the disclosure, the user device 214 is an exemplary embodiment of the EUD 106. Similarly, the system 202 is an exemplary embodiment of the computer 102 in FIG. 1.

The system 202 includes suitable logic, circuitry, and/or that is configured for predicting the diversion of an aerial vehicle in real time. The system 202 retrieves the operation data 210 associated with an aerial vehicle. The operation data includes the historical operation data 210A and the current operation data 210B. The historical operation data 210A is associated with a destination of the aerial vehicle and the current operation data 210B is associated with an operation of the aerial vehicle. The system 202 applies the first model 204 to the historical operation data 210A. The system 202 generates a deviance score for each diversion parameter of a set of diversion parameters based on the application of the first model. Each diversion parameter of the set of diversion parameters is associated with a diversion of the aerial vehicle from the destination. The system 202 determines a subset of diversion parameters from the set of diversion parameters based on the deviance score. The system 202 generates a second model for each diversion parameter of the subset of diversion parameters. The second model is generated based on the current operation data 210B. The system 202 determines probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. The system 202 generates diversion data for the diversion of the aerial vehicle from the destination. The diversion data is generated based on the probability data. The system 202 outputs the diversion data.

Examples of the system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 may be embodied as a cloud-based service, a cloud-based application, a cloud-based platform, a remote server-based service, a remote server-based application, a remote server-based platform, or a virtual computing system.

The WAN 104 facilitates seamless communication between the various elements of the network environment 200. The WAN 104 ensures data transfer and coordination among the system 202, the first model 204, the second model 206, the server 212, the one or more data sources 208, and the user device 214. This integrated environment enables the real-time prediction of diversion of the aerial vehicle.

In an example, the first model 204 corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Output of each of the nodes in the input layer may be coupled to at least one node of the hidden layer(s). Similarly, the inputs of each hidden layer are coupled to outputs of at least one node in the one or more hidden layers or the input layer of the neural network. Node(s) in a final or last layer may receive inputs from at least one hidden layer to output a result.

The number of layers and the number of nodes in each layer of the first model 204 may be determined from hyper-parameters of the first model 204. Such hyper-parameters may be set before or while training the first model 204 on a training dataset. Each node of the first model 204 corresponds to a mathematical function (e.g., a sigmoid 2 function or a rectified linear unit) with a set of parameters, tunable during the training of the first model 204. The set of parameters includes, for example, a weight parameter, a regularization parameter, and the like. Each node uses the mathematical function to compute an output based on one or more inputs from nodes in various layer(s) (e.g., previous layer(s)) of the first model 204. All or some of the nodes of the first model 204 correspond to the same or a different mathematical function.

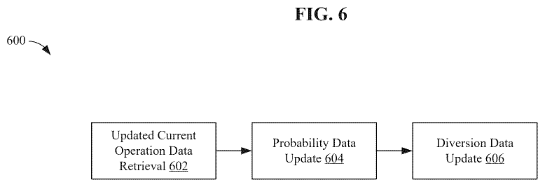

In the training of the first model 204, a set of parameters of each node of the first model 204 may be updated based on whether an output of the final layer for a given input matches a correct result (or ground truth data) based on a loss function for the first model 204. The above process may be repeated for the same or a different input until a minima of loss function may be achieved, and a training error may be minimized. Details associated with the training of the first model 204 are described in conjunction with, for example, FIG. 6A.

The first model 204 includes electronic data, such as, for example, a software program, code of the software program, libraries, applications, scripts, or various logics or instructions for execution by a processing device, such as circuitry. The first model 204 may be implemented using a hardware including a processor, a microprocessor (e.g., to perform or control the performance of one or more operations), a field-programmable gate array (FPGA), or an application-specific integrated circuit (ASIC). Alternatively, in some embodiments, the first model 204 may be implemented using a combination of hardware and software. Accordingly, in some embodiments, the first model 204 is a separate entity in the system 202, without deviation from the scope of the disclosure.

In various embodiments of the disclosure, the system 202 trains the first model 204 for classifying the subset of diversion parameters based on the set of diversion parameters associated with the operation data 210. The current operation data 210B may include flight operations records, weather conditions, air traffic patterns, flight schedules for the target destination, and the like. Further, the set of diversion parameters may be associated with the weather conditions. The system 202 adjusts the weights and the regularization parameters of the neural network corresponding to the first model 204 based on the training data to train the first model 204 for performing the classification of the set of diversion parameters.

In an embodiment of the disclosure, the system 202 stores the first model 204. In an alternate embodiment of the disclosure, the first model 204 is embodied as a cloud-based service, a cloud-based application, or a cloud-based platform. Examples of the first model 204 may include, but are not limited to, a logistic regression model, tree-based regression models, state vector machine, k-nearest neighbor model, log-binomial regression model, Poisson regression model, cox regression model, and the like.

In an example, each second model 206 for each of the diversion parameters may correspond to a Hidden Markov Model (HMM). The second model 206 is a statistical model that represents systems characterized by hidden states and observable events. It is based on the Markov process, which assumes that a future state of a system depends on its current state and not on its previous state. The second model 206 is particularly useful for modeling time series data where the underlying states are not directly observable, allowing for the analysis of sequential data.

The second model 206 is composed of several fundamental components, such as a finite set of hidden states, a finite set of observable events, transition probabilities that define the likelihood of moving from one state to a second or a different state, emission probabilities that specify the likelihood of observing a particular event given a hidden state, and an initial state distribution that describes the probabilities of starting in each hidden state. The hidden states represent the underlying processes that generate the observable events, while the observable events are the data that can be measured.

Training the second model 206 involves estimating the model parameters, including transition and emission probabilities, from a set of training data. This may be achieved using the Expectation-Maximization (EM) algorithm, specifically the Baum-Welch algorithm, which iteratively refines the estimates to maximize the likelihood of the observed data. The training data for the second model 206 may include sequences of observable events, which are used to infer the relationships between the hidden states and the observable outcomes. Details about these algorithms are omitted for the sake of brevity.

In various embodiments of the present disclosure, the second model 206 is configured to generate diversion data associated with a destination. In an example, the destination may be a particular destination airport where the aerial vehicle may be set to land. Further, the diversion data may indicate a probability of diversion of the aerial vehicle from the landing at the destination. In an example, the diversion data may correspond to “98% probability of diverting” indicating that the aerial vehicle is prone to be diverted from the destination.

Each data source of the one or more data sources 208 may include an organized collection of data that may be stored and accessed electronically from a computer system (such as the system 202). Each of the one or more data sources 208 may be designed to manage, store, retrieve, and update data efficiently. In an exemplary implementation, each data source of the one or more data sources 208 may correspond to one or more databases. The one or more databases comprise flight operations records, weather conditions, air traffic patterns, and flight schedules for the destination. In such an implementation, the structure of the database corresponding to each data source of the one or more data sources 208 typically involves tables, records, and fields that can be managed through various database management systems (DBMS).

In various embodiments of the disclosure, each data source of the one or more data sources 208 stores the operation data 210. Examples of each data source of one or more data sources 208 may include but are not limited to, a relational database, a Non-Structured Query Language (SQL) database, a hierarchical database, a network database, a transactional database, a data warehouse, and a distributed database.

The server 212 includes suitable logic, circuitry, interfaces, and/or code that stores the operation data 210 and/or data associated with the prediction of the diversion of the aerial vehicle. In an example, the server 212 may also store the first model 204 and the second model 206. The server 212 may be implemented as a cloud server and may execute operations through web applications, cloud applications, HTTP requests, repository operations, file transfer, and the like. Various example implementations of the server 212 include but are not limited to, a database server, a file server, a web server, a media server, an application server, a mainframe server, or a cloud computing server.

In various embodiments of the disclosure, the server 212 functions as a central repository for operation data 210, or a part of the operation data 210. This server is equipped with high-performance processors, extensive memory, and large storage capacities to handle the computational demands of predicting sequences of aircraft diversion. The server 212 includes high-performance processors, such as multi-core Central Processing Units (CPUs) and Graphics Processing Units (GPUs), to efficiently execute algorithms and simulations. The server 212 is also equipped with a memory, including Random Access Memory (RAM) capacities, to facilitate the rapid processing of large datasets. Additionally, the server 212 has substantial storage capacities, utilizing SSDs or HDDs, to store the historical data and the results of the simulations.

The user device 214 includes suitable logic, circuitry, and/or interfaces that are configured to execute one or more tasks within the network environment 200. The user device 214 performs the one or more tasks such as receiving data, processing the data, and transmitting the data. The user device 214 provides interfaces for the user 216 to interact with the system 202, monitor weather conditions at the destination, and receive the diversion data. In certain cases, the system 202 is also configured to generate recommendations, such as a recommended diverted path, a recommended diverted destination, and the like based on the diversion data. To this end, such recommendations are also provided to the user 216 via the user device 214. The user device 214 may include computers, tablets, or smartphones that are connected to the WAN 104, enabling remote access and control.

In various embodiments of the disclosure, the system 202 renders the diversion data on the user device 214. The system 202 determines the diversion data associated with the aerial vehicle based on an application of the first model 204 and the second model 206. Examples of the user device 214 include one but are not limited to, a computer workstation, a laptop, a smartphone, a cellular phone, a mobile phone, a consumer electronic (CE) device, an Internet of Things (IOT) device, a computing device, a mainframe machine, a server, or the like.

In operation, the system 202 is configured to retrieve the operation data 210 associated with an aerial vehicle. In various embodiments of the disclosure, the operation data 210 further includes the historical operation data 210A and the current operation data 210B. The historical operation data 210A is associated with a destination of the aerial vehicle. The destination corresponds to a destination landing location or a destination airport of the aerial vehicle. In an example, the historical operation data 210A includes at least one of historical flight operations records at the destination, historical weather condition data at the destination, historical air traffic pattern data at the destination, or historical flight schedule data at the destination. In an example, the historical operation data 210A may indicate accumulated information about past flight operations at the destination indicating diverted and non-diverted flights related data at the destination and operations data associated with the destination.

Further, the current operation data 210B is associated with an operation of the aerial vehicle. In an example, the current operation data 210B includes at least one of real-time flight data associated with the aerial vehicle, real-time weather data associated with the destination of the aerial vehicle, real-time air traffic data associated with a flight path or the destination of the aerial vehicle, or real-time runway condition data associated with the destination of the aerial vehicle. Moreover, the current operation data 210B may include but is not limited to, current weather of the destination, air traffic controls, flight logs, and the like. For example, the current operation data 210B includes unprocessed information associated with the destination collected in real-time or in near real-time, characterized by time-stamped entries that allow for analysis of trends, patterns, and anomalies. In various embodiments of the disclosure, the system 202 retrieves the historical operation data 210A and the current operation data 210B from the one or more data sources 208.

Thereafter, the system 202 is configured to apply the first model 204 to the historical operation data 210A. In an example, the first model 204 corresponds to a regression model. For example, the first model 204 is applied to the historical operation data 210A to solve a classification problem. In particular, the first model 204 is configured to generate a binary classification for input variables, such as a set of diversion parameters to produce a deviance score for each diversion parameter of the set of diversion parameters. The deviance score may lie between a range of, for example, 0 and 1.

In this regard, the system 202 is configured to generate a deviance score for each diversion parameter of the set of diversion parameters based on the application of the first model 204 to the historical operation data 210A. In an example, each diversion parameter of the set of diversion parameters is associated with a diversion of the aerial vehicle from the destination. In particular, the set of diversion parameters corresponds to variables associated with environmental conditions or weather that may influence the diversion of the aerial vehicle. The set of diversion parameters may include, but are not limited to, wind speed, wind direction, gust speed, visibility, occurrence of lightning, cloud cover, and the like. In an example, the set of diversion parameters may be predefined. Further, based on the application of the first model 204 to the historical operation data 210A, the system 202 generates the deviance score for each diversion parameter of the set of diversion parameters. For example, the deviance score of a diversion parameter may indicate how greatly or how slightly the diversion parameter affects the diversion of the aerial vehicle from the destination.

Further, the first model 204 may be used to generate the deviance score for each diversion parameter of the set of diversion parameters by evaluating a contribution of each diversion parameter in the deviation of the aerial vehicle from the destination. For example, the logistic regression model may identify weights associated with each diversion parameter of the set of diversion parameters. The weights may indicate the contribution of each diversion parameter of the set of diversion parameters in the deviation of the flight from the destination. Further, based on the weights the logistic regression model may determine the corresponding deviance score. The deviance score associated with each diversion parameter of the set of diversion parameters can be expressed in Table 1 below:

TABLE 1
Deviance Score

| One or more Parameters | Deviance Score |
|---|---|
| Wind Speed | 0.89 |
| Wind Direction | 0.70 |
| Visibility | 0.9 |
| Gust Speed | 0.6 |
| Lightning | 0.41 |

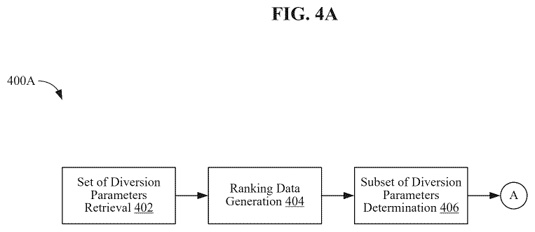

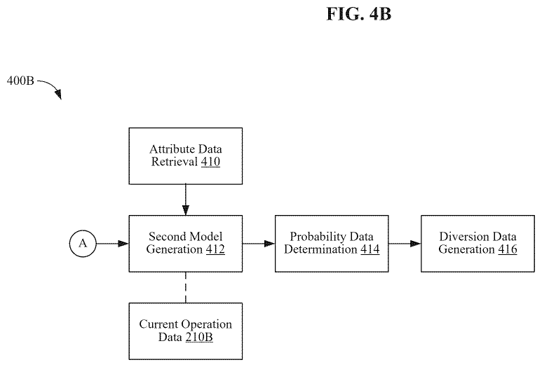

Thereafter, the system 202 is configured to determine a subset of diversion parameters from the set of diversion parameters based on the deviance score. For example, the system 202 utilizes the deviance score associated with each diversion parameter of the set of diversion parameters to determine the subset of diversion parameters. In an example, the system 202 may rank each diversion parameter of the set of diversion parameters based on the contribution of each diversion parameter in the deviation of the aerial vehicle from the destination. The ranking is done based on the deviance score. For example, a diversion parameter having a higher deviance score is ranked higher, while a diversion parameter having a lower deviance score is ranked lower. Further, based on a predefined threshold, the system 202 may determine the subset of diversion parameters. For example, the diversion parameters having a rank higher than the predefined threshold may be identified as the subset of diversion parameters that greatly contribute to the diversion of the aerial vehicle from the destination. The operations associated with the determination of the subset of diversion parameters are further described in conjunction with, for example, FIG. 4A.

By way of example, and not by limitation, using the deviance scores from the previous table, the system 202 determines the subset of diversion parameters as wind speed, wind direction, and visibility. The subset of diversion parameters is further used for subsequent modeling and prediction of diversion data for the aerial vehicle.

Continuing further, the system 202 is configured to generate a second model for each diversion parameter of the subset of diversion parameters. The second model is generated based on the current operation data 210B. It may be noted, the current operation data 210B may indicate real-time or near real-time values of various diversion parameters at the destination or associated with the flight path or flight operations of the aerial vehicle. In an example, the current operation data 210B may be expressed in Table 2 below:

TABLE 2
Set of Diversion Parameters

| Diversion Parameters | Data | |
|---|---|---|
| Visibility | 2 | miles |
| Wind Direction | 210 | Degree |
| Wind Speed | 30-40 | knots |
| Gust Speed | 50 | knots |

| | |
|---|---|
| Lightning Detected | Yes |

The system 202 generates a second model for each diversion parameter of the subset of diversion parameters. To this end, the second model 206 may be generated for the subset of diversion parameters. Each of the plurality of second models 206 is generated to analyze each diversion parameter of the subset of diversion parameters identified earlier. In an example, the second model 206 corresponds to HMM. The second model 206 is specifically designed to model sequential or time-dependent data, making it ideal for capturing temporal variations in parameters like wind speed, visibility, and wind direction. The system 202 may generate a second model for each diversion parameter of the subset of diversion parameters to model the behavior of the corresponding diversion parameter over time.

Further, the system 202 is configured to determine probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters.

In an example, each of the plurality of second models 206 may be trained on historical attribute data to identify a finite set of states associated with corresponding diversion parameters of the subset of diversion parameters. In an example, a first diversion parameter of the subset of diversion parameters may correspond to “visibility.” Further, the finite set of states associated with the first diversion parameter of “visibility” may include, but are not limited to, instrument flight rules (IFR), low instrument flight rules (LIFR), marginal visual flight rules (MVFR), visual flight rules (VFR). Further, the second model 206 may identify a set of transition probabilities associated with each of the IFR, LIFR, MVFR, and VFR. Similarly, the second model 206 may identify the finite set of states and determine the set of transition probabilities associated with each diversion parameter, such as visibility, wind speed, and wind direction of the subset of diversion parameters.

Based on the set of transition probabilities of a second model associated with a particular diversion parameter of the subset of diversion parameters, the system 202 is configured to determine the probability data for the particular diversion parameter. The probability data of the particular diversion parameter may indicate a probability of the diversion of the aerial vehicle from the destination due to the particular diversion parameter or changes in the particular diversion parameter over time.

Further, the system 202 is configured to generate the diversion data for the diversion of the aerial vehicle from the destination. The diversion data is generated based on the probability data of each diversion parameter of the subset of diversion parameters. In an example, the diversion data is generated based on a weighted average of the probability data of each diversion parameter of the subset of diversion parameters. The system 202 combines the probability data associated with each diversion parameter of the subset of diversion parameters generated by the second model 206 of each of the subset of diversion parameters to compute the diversion data. In an example, the diversion data may indicate a likelihood of the diversion of the aerial vehicle given current weather conditions and flight operations data, as well as predicted weather conditions and flight operations data at the time of landing.

Thereafter, the system 202 is configured to output the diversion data. In an example, the diversion data is transmitted to the user device 214 for output thereof. For example, the diversion data is provided as a score in a range of 0 to 1 or a percentage indicating a likelihood of the diversion of the aerial vehicle. In an embodiment, the output of the diversion data may include rendering the diversion data in a predefined user interface. In an alternate embodiment, the output of the diversion data may include providing the diversion data for a downstream task, such as generation of navigation instructions, generation of updated flight operations data, and the like.

In various embodiments of the disclosure, the system 202 is also configured to output the diversion data in association with the first model 204 and the second model 206. In this regard, the output diversion data along with the first model 204 and the second model 206 are stored, such as in the persistent storage 120 or the storage 122B. Further, the first model 204 and the second model 206 may be updated based on any change in operation of the aerial vehicle to generate updated diversion data. In certain cases, the first model 204 and the second model 206 may also be retrieved for the prediction of diversion of a different aerial vehicle traveling to the same destination or a destination having similar weather conditions and similar flight operations characteristics.

In various embodiments of the disclosure, the system 202 outputs the diversion data, in its percentage form, to the user device 214. For example, the user device 214 may include, but is not limited to, IRROPS (Irregular Operations) Manager Dashboard. The IRROPS Manager Dashboard is a centralized interface accessible to airline decision-makers, such as pilots, flight operations crew, and IRROPS Managers and the like.

By way of example, and not by limitation, the system 202 outputs the diversion data in its percentage form to the user device (e.g., IRROPS Manager Dashboard). The diversion data is displayed in a clear, visually distinct format (e.g., “70%” likelihood of diversion). The dashboard dynamically updates the diversion data as new real-time or near real-time data is received and processed by the second model 206. The dashboard also displayed alerts and recommendations generated by the system 202 based on the diversion data, such as rerouting suggestions or contingency planning and the like. The dashboard displays information, such as flight ID, destination, diversion data, and recommendations to the users. Details associated with generating the diversion data based on the probability data are described in conjunction with, for example, FIG. 4B.

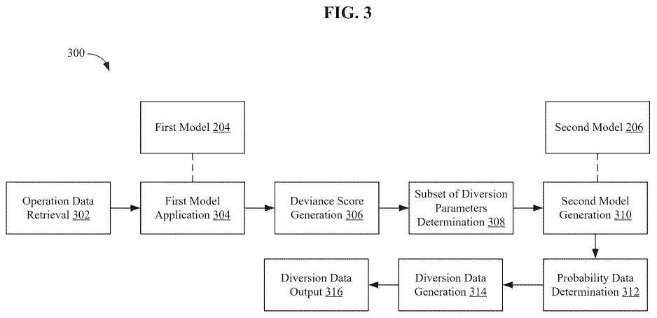

FIG. 3 is a block diagram 300 that illustrates exemplary operations for the prediction of aerial vehicle diversion, in accordance with various embodiments of the disclosure. FIG. 3 is explained in conjunction with elements of FIG. 1 and FIG. 2. With reference to FIG. 3, there is shown the block diagram 300 that illustrates exemplary operations from 302 to 316, as described herein. The exemplary operations illustrated in the block diagram 300 start at 302 and are performed by any computing system, apparatus, or device, such as by the computer 102 of FIG. 1 or by the system 202 of FIG. 2. Although illustrated with discrete blocks, the exemplary operations associated with one or more blocks of the block diagram 300 can be divided into additional blocks, combined into fewer blocks, or eliminated, depending on the implementation.

At 302, an operation data retrieval operation is performed. In the operation data retrieval operation, the system 202 retrieves the operation data 210 associated with an aerial vehicle. The operation data 210 includes historical operation data 210A and current operation data 210B. The operation data may be retrieved from the one or more data sources 208. The historical operation data 210A includes historical flight operations records, historical weather condition data, historical air traffic pattern data, and/or historical flight schedule data. In an example, the historical flight operations records may indicate operations data of flights or aerial vehicles that arrived at and/or departed from the destination, e.g., the destination airport. The historical flight operations records may include information about aerial vehicles or flights, such as type of aircraft, manufacturing information, maintenance information, operational data, personnel data associated with personnel associated with the aerial vehicles, and the like. Further, the historical weather condition data may include historical atmospheric weather conditions, historical land weather conditions, and historical ocean weather conditions at the destination, such as a runway of the destination airport, and/or areas near the destination. The historical air traffic pattern data may indicate data associated with a standard path followed by historical flights when taking off or landing while maintaining visual contact with an airfield at the destination. Moreover, the historical flight schedule data may include flight schedules of landing and takeoff of various aerial vehicles at the destination.

In an example, the historical weather condition data is indicative of historical readings associated with the set of diversion parameters. For example, the set of diversion parameters may include wind speed, wind direction, gust speed, visibility, ceiling, cloud cover 1, cloud cover 2, and occurrence of lightning.

In addition, the system 202 is configured to retrieve the current operation data 210B from the one or more data sources 208. The current operation data 210B may be received at a specific time instance “t”, which indicates the current time, thereby enabling the system 202 to review and respond to dynamic flight conditions effectively. The current operation data 210B may include various real-time parameters associated with the aerial vehicle, such as real-time flight data associated with the aerial vehicle, real-time weather data associated with the destination, real-time air traffic data, or real-time runway condition data associated with the destination. The real-time flight data may indicate, for example, aircraft details, fuel consumption data, maintenance data, flight path, flight schedule, and so forth. The real-time weather data associated with the destination may indicate weather conditions, such as wind speed, wind direction, cloud cover, visibility, atmospheric particulate matter data, and the like at the runway or airfield of the destination. The real-time air traffic data may indicate air traffic at the destination, as well as air traffic along a path to be followed by the aerial vehicle. Further, the real-time runway condition data may indicate real-time weather conditions as well as operational condition data at the runway of the aerial vehicle.

At 304, a first model application operation is performed. In the first model application operation, the system 202 applies the first model 204 on the retrieved historical operation data 210A. In an example, the first model 204 may be a logistic regression model that identifies a deviance score associated with each diversion parameter of the set of diversion parameters.

At 306, a deviance score generation operation is performed. In the deviance score generation operation, the system 202 is configured to generate a deviance score for each diversion parameter of the set of diversion parameters based on the application of the first model 204 to the historical operation data 210A. Each diversion parameter of the set of diversion parameters is associated with a diversion of the aerial vehicle from the destination. In various embodiments, the first model 204 may apply one or more processes to the obtained historical operation data 210A to generate the deviance score associated with each diversion parameter of the set of diversion parameters. The first model 204 may be trained on the historical operation data to calculate the weight associated with each diversion parameter of the set of diversion parameters such as “b1” for the wind speed, “b2” for the gust speed, “b3” for the visibility, “b4” for the ceiling, “b5” for cloud cover 1, and “b6” for cloud cover 2. The weight associated with each diversion parameter of the set of diversion parameters can be represented in Table 3 below:

TABLE 3
Weights

| weight | Corresponding value |
|---|---|
| “b1” | 0.0950 |
| “b2” | 0.0145 |
| “b3” | −0.0003 |
| “b4” | −1.242e−05 |
| “b5” | 0.0031 |
| “b6” | 0.0065 |

Further, the first model 204 may utilize the weight of a diversion parameter of the set of diversion parameters to calculate the deviance score associated with the diversion parameter. The deviance score may indicate the effect of a particular diversion parameter of the set of diversion parameters on the deviation of the aerial vehicle from the destination. The deviance score associated with each diversion parameter of the set of diversion parameters can be expressed in Table 4 below:

TABLE 4
Deviance Score

| Set of Diversion Parameters | Deviance Score |
|---|---|
| “Wind speed” | 145.19 |
| “Gust speed” | 6.37 |
| “visibility” | 370.97 |
| “Ceiling” | 118.85 |
| “Cloud cover1” | 21.1 |
| “Cloud cover2” | 24.88 |

At 308, a subset of diversion parameters determination operation is performed. In the subset diversion parameters determination operation, the system 202 determines the subset diversion parameters from the set of diversion parameters based on the deviance score. Further, the subset of diversion parameters is determined based on a predefined threshold. In an example, the predefined threshold may correspond to “2”.

By way of example, and not by limitation, the system 202 may select top-ranked, such as top four diversion parameters based on the corresponding deviance score. By way of example, and not by limitation, the system 202 selects diversion parameters having deviance scores greater than the predefined threshold of “2”. The identified one or more parameters that are top-ranked or have a deviance score greater than the predefined threshold may correspond to the subset of diversion parameters. In an example, the subset of diversion parameters may be, for example, wind speed and visibility.

At 310, a second model generation operation is performed. In the second model generation operation, the system 202 is configured to generate a second model for each diversion parameter of the subset of diversion parameters. In an example, the second model 206 is generated based on the identified subset of diversion parameters. Moreover, the second model 206 is generated based on the current operation data 210B. In an example, the second model 206 is a hidden Markov model. The second model 206 corresponding to a diversion parameter of the subset of diversion parameters is generated based on real-time values of the diversion parameter from the current operation data 210B. Details associated with generating the second model 206 for each diversion parameter of the subset of diversion parameters are described in conjunction with, for example, FIG. 4B.

In various embodiments, the system 202 may retrieve attribute data associated with each attribute of a plurality of attributes. In an example, the plurality of attributes is associated with a specific diversion parameter of the subset of diversion parameters. The plurality of attributes of the specific diversion parameter may correspond to various types or ranges of the diversion parameter. For example, for the diversion parameter corresponding to “visibility”, the plurality of attributes may correspond to variables or features associated with visibility, such as the IFR, LIFR, MVFR, and VFR. The attribute data for each attribute of the plurality of attributes may be determined based on a training of the second model 206 corresponding to “visibility”.

Further, the system 202 is configured to specify a plurality of states of the second model 206 associated with the specific diversion parameter based on the attribute data. It may be noted that the second model 206 may include a root node that corresponds to the specific diversion parameter. The plurality of states may correspond to hidden states of the HMM or the second model 206. The plurality of states may be the underlying variables that generate the observed data, but they are not directly observable. In an example, the root node of the second model 206 corresponds to “visibility”. In such a case, the plurality of states of the second model 206 associated with the diversion parameter “visibility” may correspond to IFR, LIFR, MVFR, and VFR. In this regard, each state of the plurality of states corresponds to an attribute of the plurality of attributes. For example, a first state of the second model 206 corresponds to IFR, a second state of the second model 206 corresponds to LIFR, a third state of the second model 206 corresponds to MVFR, and a fourth state of the second model 206 corresponds to VFR. In an example, the plurality of states of the second model 206 may have a same order, e.g., may lie at a same level from the root node. In an alternate example, the plurality of states of the second model 206 may have a hierarchical order.

The system 202 is further configured to specify a pair of output states of the second model 206. The pair of output states may correspond to the last or lowest layer of the second model 206. Pursuant to embodiments of the present disclosure, the pair of output states includes a first output state associated with the diversion of the aerial vehicle from the destination and a second output state associated with a landing of the aerial vehicle at the destination. Subsequently, the pair of output states of the second model 206 may correspond to “diversion” and “no diversion”. To this end, the pair of output states of the second model 206 for each diversion parameter of the subset of diversion parameters may be the same, e.g., “diversion” and “no diversion”. In an example, the pair of output states correspond to variables that are measured and observed at the output of the second model 206 or HMM.

At 312, a probability data determination operation is performed. In the probability data determination operation, the system 202 is configured to determine probability data for each diversion parameter of the subset of diversion parameters based on the second model for each diversion parameter of the subset of diversion parameters. The probability data indicates a probability of the diversion of the aerial vehicle from the destination due to the corresponding diversion parameter of the subset of diversion parameters. In an example, the probability data for the specific diversion parameter of the subset of diversion parameters is determined based on the set of emission probabilities of the second model 206 corresponding to the specific diversion parameter. For example, the set of emission probabilities of the second model 206 may indicate a probability of reaching a particular output state given a hidden state. Subsequently, the probability data of the specific diversion parameter is determined based on probabilities of reaching or observing each of the pair of output states from each of the plurality of states. In an example, based on the identified relationships in the second model 206 associated with the specific diversion parameter, the system 202 is configured to generate the probability data associated with the specific diversion parameter of the subset of diversion parameters.

At 314, a diversion data generation operation is performed. In the diversion data generation operation, the system 202 is configured to generate the diversion data for the aerial vehicle based on the probability data of each diversion parameter of the subset of diversion parameters. In an example, the diversion data may indicate a score, a probability, or a percentage of a likelihood of diversion of the aerial vehicle from landing at the destination. In an example, the system 202 combines or calculates a weighted average of the probability data associated with each diversion parameter from the subset of diversion parameters to generate the diversion data. In an alternate example, the system 202 may use a statistical method to combine the probability values associated with each diversion parameter of the subset of diversion parameters. The system 202 ensures that the probability does not go above 100% or outside of a range of 0 to 1. In an example, the diversion data is generated based on:

$${P}_{( Diversion )} = 1 - {\prod }_{i = 1}^{n} ( 1 - {P}_{i} )$$

$$or$$

$${P}_{( Diversion )} = 1 - [ ( 1 - {P}_{1} ) * ( 1 - {P}_{2} ) * … ]$$

By way of example, and not by limitation, if the probability data associated with the wind speed corresponds to 0.4 and the probability data associated with the visibility corresponds to 0.2, the system 202 calculates an overall diversion data of 0.52 based on the cumulative effects of wind speed and visibility on the diversion of the aerial vehicle associated with the destination. For example, based on P₁ (Wind Speed): 40% or 0.4 and P₂ (Visibility): 20% or 0.2, the diversion data is calculated as:

$${P}_{( Diversion )} = 1 - [ ( 1 - 0.4 ) * ( 1 - 0.2 ) ] = 0.52$$

At 316, a diversion data output operation is performed. In the diversion data output operation, the system 202 is configured to output the diversion data to the user device 214. In various embodiments of the disclosure, the system 202 is configured to output the diversion data for apprising a user, such as a pilot, cabin crew, or a user associated with the aerial vehicle, about the chances of the diversion.

FIG. 4A is a block diagram 400A that illustrates exemplary operations for determining the subset of diversion parameters from the set of diversion parameters for predicting aerial vehicle diversion, in accordance with various embodiments of the disclosure. FIG. 4A is explained in conjunction with elements from FIG. 1, FIG. 2, and FIG. 3. With reference to FIG. 4A, there is shown the block diagram 400A that illustrates exemplary operations from 402 to 406, as described herein. The exemplary operations illustrated in the block diagram 400A start at 402 and are performed by any computing system, apparatus, or device, such as by the computer 102 of FIG. 1 or the system 202 of FIG. 2. Although illustrated with discrete blocks, the exemplary operations associated with one or more blocks of the block diagram 400A are divided into additional blocks, combined into fewer blocks, or eliminated, depending on the implementation.

At 402, a set of diversion parameters retrieval operation is performed. In the set of diversion parameters retrieval operation, the system 202 is configured to retrieve the set of diversion parameters associated with the destination. The set of diversion parameters may indicate all possible variables or parameters that may influence the diversion of aerial vehicles. For example, the set of diversion parameters may correspond to environment or weather-related variables that may influence the diversion of the aerial vehicle at the destination. The environment or weather-related variables may include, but are not limited to, an occurrence of lightning, wet runway conditions, visibility, wind conditions, and thunderstorms. In certain cases, some diversion parameters of the set of diversion parameters may also correspond to operation-related variables, such as fuel levels and aircraft performance. For example, the set of diversion parameters is retrieved from the one or more data sources 208.

In an example, the set of diversion parameters is predetermined, for example, based on historical diversion data. The historical diversion data may indicate a reason or a particular variable causing the diversion of an aerial vehicle. To this end, such variables may be identified as the set of diversion parameters. In an example, the set of diversion parameters may be determined based on parsing a large amount of historical diversion data by an AI model or an ML model. In an alternate example, the set of diversion parameters may be defined manually.

At 404, a ranking data generation operation is performed. In the ranking data generation operation, the system 202 is configured to generate ranking data using the first model 204. The first model 204 is applied to the obtained historical operation data 210A to evaluate an influence of each diversion parameter of the set of diversion parameters for the diversion of the aerial vehicle from the destination. In an example, the ranking data is generated based on the deviance score of each diversion parameter of the set of parameters.

It may be noted, the system 202 applies the first model 204 to the historical operation data 210A to determine the deviance score of each diversion parameter of the set of diversion parameters. Based on the deviance score, the set of diversion parameters is ranked. The ranking data may indicate a rank of each diversion parameter of the set of diversion parameters contributing to the diversion of the aerial vehicle from the destination. For example, diversion parameters associated with severe weather conditions (e.g., thunderstorms, low visibility) may receive a higher deviance score, hence ranking indicating a stronger contribution to the diversion of the aerial vehicle.

At 406, a subset of diversion parameters determination operation is performed. In the subset of diversion parameters determination operation, the system 202 is configured to determine the subset of diversion parameters from the set of diversion parameters based on the ranking data. In various embodiments of the disclosure, the system 202 is configured to select top-ranked parameters based on the generated ranking data. Once the set of diversion parameters is ranked, the system 202 selects a predefined number of top-ranking diversion parameters that are identified as having a direct and consistent relationship with flight diversions at the destination. The top-ranking diversion parameters are prioritized for further analysis. In other words, the predefined number of top-ranking diversion parameters may have a significant impact on predicting the flight diversions at the destination. To this end, based on the historical operation data 210A, the subset of diversion parameters is determined. Determining the subset of diversion parameters ensures that the effect of influential parameters is used for predicting the diversion of the aerial vehicle.

For example, if the ranking data shows that visibility and thunderstorms have a significant impact on flight diversion outcomes, the system 202 would select these diversion parameters for further analysis. Pursuant to the present disclosure, impact indicates a degree to which a diversion parameter impacts safety, efficiency, and/or success of a flight operation. A specific diversion parameter (such as visibility, wind speed, temperature, and the like) from the predefined number of top-ranking diversion parameters is considered to have a significant impact or a significant influence as the specific diversion parameter may substantially affect a flight's trajectory, performance, and decision-making processes. Changes in the specific diversion parameter may require careful consideration and may necessitate adjustments to the flight plan or even a complete diversion. By narrowing down the selection, the generation and analysis of the second model 206 for each of the subset of diversion parameters becomes more focused, reducing compute load and complexity while improving the accuracy of the prediction of the diversion data.

FIG. 4B is a block diagram 400B that illustrates exemplary operations for generating diversion data for predicting aerial vehicle diversion, in accordance with various embodiments of the disclosure. FIG. 4B is explained in conjunction with elements from FIG. 1, FIG. 2, FIG. 3, and FIG. 4A. With reference to FIG. 4B, there is shown the block diagram 400B that illustrates exemplary operations from 410 to 412, as described herein. The exemplary operations illustrated in the block diagram 400B start at 410 and are performed by any computing system, apparatus, or device, such as by the computer 102 of FIG. 1 or the system 202 of FIG. 2. Although illustrated with discrete blocks, the exemplary operations associated with one or more blocks of the block diagram 400B are divided into additional blocks, combined into fewer blocks, or eliminated, depending on the implementation.

At 410, an attribute data retrieval operation is performed. In various embodiments of the disclosure, the system 202 is configured to retrieve attribute data associated with the plurality of attributes of each diversion parameter of the subset of diversion parameters. The attribute data corresponds to specific categories or classifications related to each diversion parameter from the subset of diversion parameters. The attribute data represents granular information that provides additional context to improve the accuracy of predictions.

By way of example, and not by limitation, if the selected diversion parameter is visibility, its associated attributes may include LIFR, IFR, MVFR, and VFR. LIFR indicates conditions of extremely poor visibility (e.g., visibility<1 mile). LIFR is depicted in Magenta on flight planning software. IFR indicates conditions where instruments are needed (e.g., visibility between 1-3 miles). IFR is depicted in red on flight planning software. MVFR indicates moderate visibility conditions (e.g., visibility between 3-5 miles). MVFR is depicted in blue on flight planning software. VFR indicates conditions with clear visibility (e.g., visibility>5 miles). VFR is depicted in green on flight planning software.

For example, for the selected diversion parameter wind speed, the attribute data is associated with attributes, such as low speed, high speed, and medium speed. Low Speed indicates wind speed<10 knots, medium speed indicates wind speed between 10 and 25 knots, and high speed indicates wind speed>25 knots.

At 412, a second model generation operation is performed. In the second model generation operation, the system 202 is configured to generate the second model 206 for each diversion parameter of the subset of diversion parameters. In an example, the plurality of states of the second model 206 associated with a specific diversion parameter may correspond to the plurality of attributes associated with the specific diversion parameter. Further, the second model 206 associated with the specific diversion parameter may include a first output state corresponding to the diversion of the aerial vehicle from the destination, and a second output state corresponding to the landing of the aerial vehicle at the destination.

In an example, the second model 206 is composed of, for example, a finite set of hidden states, a finite set of observable events, transition probabilities that define the likelihood of moving from one state to a second or a different state, emission probabilities that specify the likelihood of observing a particular event given a hidden state, and an initial state distribution that describes the probabilities of starting in each hidden state. Further, the set of transition probabilities and the set of emission probabilities of the second model 206 are determined based on the real-time data, e.g., the current operation data 210B. Details associated with the generation of the second model 206 for each diversion parameter of the subset of diversion parameters are described in conjunction with, for example, FIG. 3.

At 414, a probability data determination operation is performed. In the probability data determination operation, the system 202 is configured to determine probability data for each diversion parameter of the subset of diversion parameters based on the second model for each diversion parameter of the subset of diversion parameters.

In an example, the system 202 is configured to determine a probability distribution over the plurality of states of the second model 206 associated with the specific diversion parameter. The relationship between the plurality of states and the pair of output states is modeled using a probability distribution. The system 202 is configured to determine the probability distribution using the second model 206 based on the relationships between the plurality of states and the pair of output states using two sets of probabilities, e.g., the set of transition probabilities and the set of emission probabilities.

Thereafter, the system 202 is configured to determine the probability data associated with the specific diversion parameter based on the probability distribution. The probability data indicates a first probability of a first output state of the pair of output states and a second probability of a second output state of the pair of output states. For example, the first probability may indicate a likelihood of the diversion of the aerial vehicle from the destination due to the influence of the specific diversion parameter. Similarly, the second probability may indicate a likelihood of landing of the aerial vehicle at the destination due to the influence of the specific diversion parameter. For example, the first probability associated with the specific diversion parameter maybe 0.7, while the second probability associated with the specific diversion parameter may be 0.3. In a similar manner, the probability data associated with each diversion parameter of the subset of diversion parameters is determined. Details associated with the determination of the probability data associated with each diversion parameter of the subset of diversion parameters are described in detail in conjunction with, for example, FIG. 3.

It may be noted that the description of the second model 206 to be HMM is only exemplary. In various embodiments of the present disclosure, the second model 206 may be generated using algorithms, such as probabilistic graphical models, Bayesian fields, recurrent neural networks, or any statistical model.

In various embodiments of the disclosure, the individual probability data reflect the contribution of each diversion parameter of the subset of diversion parameters to the overall likelihood of the diversion. In an example, the individual probability data of each diversion parameter of the subset of diversion parameters may be for example, “0.6” for wind speed and “0.25” for visibility. The probability data associated with each diversion parameter of the subset of diversion parameters can be expressed in Table 5 below:

TABLE 5
Probability Data

| Parameter | Transition | Real-Time Data | Probability Data |
|---|---|---|---|
| Low Visibility | MVFR to IFR | Visibility | 0.6 |
| | transition | dropping | |
| | | to 700 miles | |
| Wind Speed | Medium | Wind speed | 0.25 |
| | to high | increased | |
| | transition | to 18 knots | |

At 416, a diversion data generation operation is performed. In the diversion data generation operation, the system 202 combines the individual probability scores of each diversion parameter of the subset of diversion parameters to calculate the final diversion data. The diversion data represents an overall likelihood of the diversion of the aerial vehicle under the current weather and operation conditions.

In various embodiments of the disclosure, the system 202 computes the diversion data by aggregating the individual probability data generated by individual second models by using various approaches, for example, but not limited to, complementary probability approach, weighted summation, weighted average, and the like. The diversion data is determined using complementary probability to account for the interdependencies between each diversion parameter of the subset of diversion parameters. Each diversion parameter contributes a probability data Pᵢ (where ‘i’ denotes the diversion parameter) calculated by its corresponding second model. These individual probabilities are combined to compute the diversion data using the complementary probability formula:

$${P}_{( Diverslon )} = 1 - {\prod }_{i = 1}^{n} ( 1 - {P}_{i} ) \qquad ( 1 )$$

where Pᵢ is a probability of the diversion contributed by the i^{th} parameter (e.g., visibility, wind speed, thunderstorm), and n is total number of selected diversion parameters. The complementary probability approach captures the interdependencies between diversion parameters by calculating the cumulative likelihood of at least one diversion parameter contributing to an aircraft diversion.

By way of example, and not by limitation, the system 202 selects the two diversion parameters, e.g., visibility and wind speed. Herein, each second model outputs probability data for the corresponding diversion parameter from the selected diversion parameter, for example, for visibility the probability data is 0.6, and for wind speed the probability data is 0.25, as shown below in Table 6:

TABLE 6
Probability Data

| Diversion Parameters | Probability Data |
|---|---|
| Low Visibility | 0.6 |
| Wind Speed | 0.25 |

For example, the system 202 uses the complementary probability of the Eq. (1) to generate the diversion data as:

$${P}_{( Diversion )} = 1 - [ ( 1 - {P}_{1} ) * ( 1 - {P}_{2} ) * … ] \\ {P}_{( Diversion )} = 1 - [ ( 1 - 0.6 ) * ( 1 - 0.25 ) ] \\ {P}_{( Diversion )} = 1 - [ 0.4 * 0.75 ] \\ {P}_{( Diversion )} = 0.7$$

The diversion data P_{(Diversion)} is a probabilistic score between 0 and 1. In an example, the probabilistic score is converted the diversion data is then converted into percentages and then rendered on the user device 214 for pilots and operations crew.

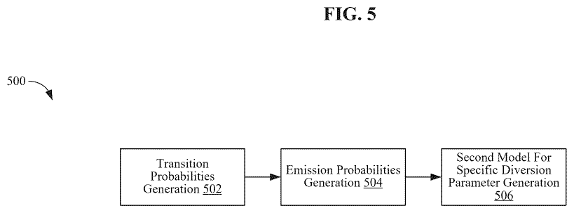

FIG. 5 is a diagram 500 that illustrates an exemplary operation for determining probability data for predicting aerial vehicle diversion, in accordance with various embodiments of the disclosure. FIG. 5 is explained in conjunction with elements of FIG. 1, FIG. 2, FIG. 3, FIG. 4A, and FIG. 4B. With reference to FIG. 5, there is shown the diagram 500 that illustrates exemplary operations from 502 to 508, as described herein. The exemplary operations illustrated in the diagram 500 start at 502 and are performed by any computing system, apparatus, or device, such as by the computer 102 of FIG. 1 or the system 202 of FIG. 2. Although illustrated with discrete blocks, the exemplary operations associated with the diagram 500 are divided into additional blocks, combined into fewer blocks, or eliminated, depending on the implementation.

At 502, a transition probabilities generation operation is performed. In the transition probabilities generation operation, the system 202 is configured to generate a set of transition probabilities for each specific diversion parameter from the subset of diversion parameters.

The system 202 is further configured to generate a set of transition probabilities between the plurality of states. In an example, each transition probability of the set of transition probabilities corresponds to a likelihood of transition of a first state of the plurality of states to a second state of the plurality of states. In an example, a transition probability of the set of transition probabilities may indicate a relationship between two states of the plurality of states. The transition probability may describe a probability of transitioning from one state, say the first state, at a first time step to a next state, say the second state at a second time step. The second time step may occur after the first time step. In an example, a transition probability of the set of transition probabilities for the second model 206 associated with the diversion parameter “visibility” may correspond to a probability value of transition from the first state corresponding to LIFR to the second state IFR.

At 504, an emission probabilities generation operation is performed. In the emission probabilities generation operation, the system 202 generates a set of emission probabilities. The system 202 is configured to generate the set of emission probabilities for the specific diversion parameter based on the set of transition probabilities. Each emission probability of the set of emission probabilities indicates a likelihood of output of one of the pair of outputs The set of emission probabilities may describe a probability of observing an output from a particular state of the plurality of states. In an example, an emission probability of the set of emission probabilities for the second model 206 associated with the diversion parameter “visibility” may correspond to a probability value of transition from the first state corresponding to LIFR to an output state corresponding to “diversion” or an output state corresponding to “no diversion”.

In an example, the system 202 is configured to determine crosswind data associated with the destination. In an example, the crosswind data is determined based on the historical operation data 210A. Moreover, the historical operation data 210A indicates one or more historical occurrences of each output state of the pair of output states. It may be noted that crosswind data is associated with a crosswind component of force, referred to as crosswind force, that acts on the aerial vehicles during take-off and/or landing. The crosswind force may deflect a flight path of the aerial vehicle in a direction of the wind. In particular, the crosswind force is a component of wind force that is blowing across the runway at the destination, making landings and take-offs more difficult than if the wind were blowing straight down the runway. To this end, if the crosswind force is strong, it may affect landing, take-off, and damage to the aerial vehicle.

Further, the system 202 is configured to generate the set of emission probabilities for the specific diversion parameter based on the crosswind data. To this end, the set of emission probabilities associated with diversion parameters corresponding to wind speed and/or wind direction may be generated based on the crosswind data.

At 506, a second model generation operation is performed. In the second model generation operation, the system 202 is configured to generate the second model 206 for a specific diversion parameter. The second model 206 is generated for the specific diversion parameter based on the plurality of states, the pair of output states, the set of transition probabilities, and the set of emission probabilities. In a similar manner, the second model for each diversion parameter of the subset of diversion parameters is generated.

In an example, the system 202 is configured to apply the Viterbi algorithm on the second model 206 for each diversion parameter of the subset of diversion parameters. The Viterbi algorithm is a Dynamic Programming (DP) algorithm that determines a highly likely sequence of hidden states from the plurality of states based on the observed data, e.g., the current operation data 210B.

FIG. 6 is a block diagram 600 that illustrates an exemplary operation for updating diversion data, in accordance with various embodiments of the disclosure. FIG. 6 is explained in conjunction with elements from FIG. 1, FIG. 2, FIG. 3, FIG. 4A, FIG. 4B and FIG. 5. With reference to FIG. 6, there is shown the block diagram 600 that illustrates exemplary operations from 602 to 606, as described herein. The exemplary operations illustrated in the block diagram 600 start at 602 and are performed by any computing system, apparatus, or device, such as by the computer 102 of FIG. 1 or the system 202 of FIG. 2. Although illustrated with discrete blocks, the exemplary operations associated with one or more blocks of the block diagram 600 are divided into additional blocks, combined into fewer blocks, or eliminated, depending on the implementation.

At 602, an updated current operation data retrieval operation is performed. In the updated current operation data retrieval operation, the system 202 is configured to retrieve updated current operation data from various sources such as airport sources, metrological services, airport sensors, and the like. The updated current operation data is retrieved after the retrieval of current operation data 210B in a fixed interval (e.g., after every 10 minutes) and includes the real-time or near real-time information such as visibility, wind speed, and the like, and operational flight data such as flight route, aircraft location and the like. The updated current operation data ensures that the system 202 dynamically adjusts to changing conditions.

At 604, a probability data update operation is performed. In the probability data update operation, the system 202 is configured to update the probability data or determine updated probability data associated with at least one diversion parameter of the subset of diversion parameters. In an example, the system 202 determines updated probability data for each diversion parameter of the subset of diversion parameters based on the updated current operation data. In this regard, the system 202 updates the second model, such as the set of transition probabilities and the set of emission probabilities of the second model associated with each diversion parameter of the subset of diversion parameters. Subsequently, based on the updated second model, the system 202 generates the updated probability data associated with each diversion parameter of the subset of diversion parameters. Details associated with the determination of the probability data are described in conjunction with, for example, FIG. 4B and FIG. 5.

At 606, a diversion data update operation is performed. In the diversion data update operation, the system 202 is configured to update the diversion data or determine updated diversion data associated with the diversion of the aerial vehicle. In an example, the updated diversion data is generated based on the updated probability data associated with each diversion parameter of the subset of diversion parameters. Details associated with the generation of the diversion data are described in conjunction with, for example, FIG. 4B.

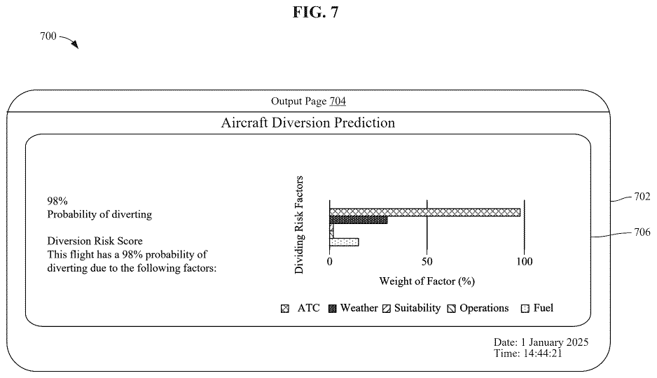

FIG. 7 is a diagram that illustrates an exemplary user interface 700 for predicting an aircraft diversion, in accordance with various embodiments of the disclosure. FIG. 7 is explained in conjunction with elements from FIG. 1, FIG. 2, FIG. 3A, FIG. 3B, FIG. 4A, FIG. 4B, FIG. 5, and FIG. 6. With reference to FIG. 7, there is shown the exemplary user interface 700 that may be rendered on the user device 702. In an example, the exemplary user interface 700 includes an output page 704. The output page 704 includes one or more UI elements, such as a UI element 706. The user device 702 is an exemplary embodiment of the user device 214 of FIG. 2.

With reference to FIG. 7, the system 202 renders the output page 704 on a display unit of the user device 702. The system 202 renders the diversion data on the output page 704 of the user device 702. The UI element 706 corresponds to a textbox that includes the Aircraft Diversion Prediction data, for example, “98% Probability of diverting.

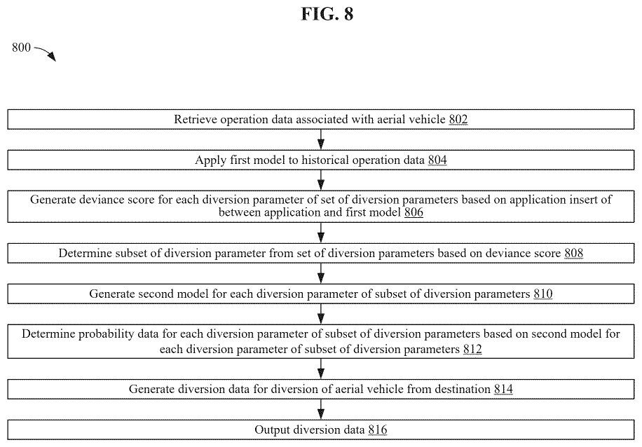

FIG. 8 is a flowchart 800 that illustrates an exemplary method for the prediction of aerial vehicle diversion, in accordance with various embodiments of the disclosure. FIG. 8 is explained in conjunction with elements from FIG. 1, FIG. 2, FIG. 3, FIG. 4A, FIG. 4B, FIG. 5, FIG. 6, and FIG. 7. With reference to FIG. 8, there is shown the flowchart 800. The operations of the exemplary method may be executed by any computing system, for example, by the computer 102 of FIG. 1 or the system 202 of FIG. 2. The operations of the flowchart 800 may start at 802.

At 802, the operation data associated with the aerial vehicle is retrieved. In various embodiments of the disclosure, the system 202 is configured to retrieve the operation data 210 associated with an aerial vehicle, wherein the operation data 210 comprises historical operation data 210A associated with a destination of the aerial vehicle and current operation data 210B associated with an operation of the aerial vehicle.

At 804, a first model is applied to the historical operation data. In various embodiments of the disclosure, the system 202 is configured to apply the first model 204 to the historical operation data 210A.

At 806, a deviance score is generated for each diversion parameter of a set of diversion parameters based on the application of the first model. In various embodiments of the disclosure, the system 202 is configured to generate a deviance score for each diversion parameter of a set of diversion parameters based on the application of the first model 204 to the historical operation data 210A, wherein each diversion parameter of the set of diversion parameters is associated with a diversion of the aerial vehicle from the destination.

At 808, a subset of diversion parameters is determined from the set of diversion parameters based on the deviance score. In various embodiments of the disclosure, the system 202 is configured to determine the subset of diversion parameters from the set of diversion parameters based on the deviance score.

At 810, a second model is generated for each diversion parameter of the subset of diversion parameters. In various embodiments of the disclosure, the system 202 is configured to generate a second model 206 for each diversion parameter of the subset of diversion parameters, wherein the second model 206 is generated based on the current operation data 210B.

At 812, probability data for each diversion parameter of the subset of diversion parameters is determined. In various embodiments of the disclosure, the system 202 is configured to determine the probability data for each diversion parameter of the subset of diversion parameters based on the second model 206 for each diversion parameter of the subset of diversion parameters, wherein the probability data indicates a probability of the diversion of the aerial vehicle from the destination due to the corresponding diversion parameter of the subset of diversion parameters.

At 814, diversion data for a diversion of the aerial vehicle from the destination is generated. In various embodiments of the disclosure, the system 202 is configured to generate diversion data for the diversion of the aerial vehicle from the destination, wherein the diversion data is generated based on the probability data.

At 816, the diversion data is output. In various embodiments of the disclosure, the system 202 is configured to output, by the computer, the diversion data.

What is claimed is:

1. A computer-implemented method, comprising:
retrieving, by a computer, operation data associated with an aerial vehicle, wherein the operation data comprises historical operation data associated with a destination of the aerial vehicle and current operation data associated with an operation of the aerial vehicle;
applying, by the computer, a first model to the historical operation data;
generating, by the computer, a deviance score for each diversion parameter of a set of diversion parameters based on the application of the first model, wherein each diversion parameter of the set of diversion parameters is associated with a diversion of the aerial vehicle from the destination;
determining, by the computer, a subset of diversion parameters from the set of diversion parameters based on the deviance score;
generating, by the computer, a second model for each diversion parameter of the subset of diversion parameters, wherein the second model is generated based on the current operation data;
determining, by the computer, probability data for each diversion parameter of the subset of diversion parameters based on the second model for each diversion parameter of the subset of diversion parameters, wherein the probability data indicates a probability of the diversion of the aerial vehicle from the destination due to the corresponding diversion parameter of the subset of diversion parameters;
generating, by the computer, diversion data for the diversion of the aerial vehicle from the destination, wherein the diversion data is generated based on the probability data; and
outputting, by the computer, the diversion data.

2. The computer-implemented method of claim 1, wherein the historical operation data comprises at least one of historical flight operations records, historical weather condition data, historical air traffic pattern data, or historical flight schedule data.

3. The computer-implemented method of claim 1, wherein the current operation data comprises at least one of real-time flight data associated with the aerial vehicle, real-time weather data associated with the destination, real-time air traffic data, or real-time runway condition data associated with the destination.

4. The computer-implemented method of claim 1, wherein the set of diversion parameters is associated with at least one of wind speed, wind direction, gust speed, visibility, or occurrence of lightning.

5. The computer-implemented method of claim 1, further comprising:
generating, by the computer, ranking data for each diversion parameter of the set of diversion parameters based on the deviance score; and
identifying, by the computer, the subset of diversion parameters from the set of diversion parameters based on the ranking data.

6. The computer-implemented method of claim 1, wherein to generate the second model for a specific diversion parameter of the subset of diversion parameters the computer-implemented method further comprises:
retrieving, by the computer, attribute data associated with each attribute of a plurality of attributes, wherein the plurality of attributes is associated with the specific diversion parameter of the subset of diversion parameters;
specifying, by the computer, a plurality of states of the second model associated with the specific diversion parameter based on the attribute data, wherein each state of the plurality of states corresponds to an attribute of the plurality of attributes;
specifying, by the computer, a pair of output states of the second model;
generating, by the computer, a set of transition probabilities between the plurality of states, wherein each transition probability of the set of transition probabilities corresponds to a likelihood of transition of a first state of the plurality of states to a second state of the plurality of states; and
generating, by the computer, a set of emission probabilities for the specific diversion parameter based on the set of transition probabilities, wherein each emission probability of the set of emission probabilities indicates a likelihood of output of one of the pair of output states given a state of the plurality of states.

7. The computer-implemented method of claim 6, further comprising:
determining, by the computer, a probability distribution over the plurality of states of the second model; and
determining, by the computer, the probability data associated with the specific diversion parameter based on the probability distribution, wherein the probability data indicates a first probability of a first output state of the pair of output states and a second probability of a second output state of the pair of output states.

8. The computer-implemented method of claim 7, wherein the first output state is associated with the diversion of the aerial vehicle from the destination, and wherein the second output state is associated with a landing of the aerial vehicle at the destination.

9. The computer-implemented method of claim 6, further comprising:
determining, by the computer, crosswind data associated with the destination, wherein the crosswind data is determined based on the historical operation data, and wherein the historical operation data indicates one or more historical occurrences of each output state of the pair of output states; and
generating, by the computer, the set of emission probabilities for the specific diversion parameter based on the crosswind data.

10. The computer-implemented method of claim 1, wherein the first model corresponds to a regression model, and wherein the second model corresponds to a Hidden Markov Model (HMM).

11. The computer-implemented method of claim 1, further comprising:
receiving, by the computer, updated current operation data;
updating, by the computer, the probability data for each diversion parameter of the subset of diversion parameters based on the updated current operation data; and
updating, by the computer, the diversion data for the diversion of the aerial vehicle from the destination, wherein the diversion data is updated based on the updated probability data.

12. A computer system, comprising:
a processor set;
one or more computer-readable storage media; and
program instructions stored on the one or more computer-readable storage media, the program instructions executable by the processor set to cause the processor set to:
retrieve operation data associated with an aerial vehicle, wherein the operation data comprises historical operation data associated with a destination of the aerial vehicle and current operation data is associated with an operation of the aerial vehicle;
apply a first model to the historical operation data;
generate a deviance score for each diversion parameter of a set of diversion parameters based on the application of the first model, wherein each diversion parameter of the set of diversion parameters is associated with a diversion of the aerial vehicle from the destination;
determine a subset of diversion parameters from the set of diversion parameters based on the deviance score;
generate a second model for each diversion parameter of the subset of diversion parameters, wherein the second model is generated based on the current operation data;
determine probability data for each diversion parameter of the subset of diversion parameters based on the second model for each diversion parameter of the subset of diversion parameters, wherein the probability data indicates a probability of the diversion of the aerial vehicle from the destination due to the corresponding diversion parameter of the subset of diversion parameters;
generate diversion data for the diversion of the aerial vehicle from the destination, wherein the diversion data is generated based on the probability data; and
output the diversion data.

13. The computer system of claim 12, wherein the historical operation data comprises at least one of historical flight operations records, historical weather condition data, historical air traffic pattern data, or historical flight schedule data.

14. The computer system of claim 12, wherein the current operation data comprises at least one of real-time flight data associated with the aerial vehicle, real-time weather data associated with the destination, real-time air traffic data, or real-time runway condition data associated with the destination.

15. The computer system of claim 12, wherein the set of diversion parameters is associated with at least one of wind speed, wind direction, gust speed, visibility, or occurrence of lightning.

16. The computer system of claim 12, wherein the program instructions further cause the processor set to:
generate ranking data for each diversion parameter of the set of diversion parameters based on the deviance score; and
identify the subset of diversion parameters from the set of diversion parameters based on the ranking data.

17. The computer system of claim 12, wherein to generate the second model for a specific diversion parameter of the subset of diversion parameters the program instructions further cause the processor set to:
retrieve attribute data associated with each attribute of a plurality of attributes, wherein the plurality of attributes is associated with the specific diversion parameter of the subset of diversion parameters;
specify a plurality of states of the second model associated with the specific diversion parameter based on the attribute data, wherein each state of the plurality of states corresponds to an attribute of the plurality of attributes;
specify a pair of output states of the second model;
generate a set of transition probabilities between the plurality of states, wherein each transition probability of the set of transition probabilities corresponds to a likelihood of transition of a first state of the plurality of states to a second state of the plurality of states;
determine crosswind data associated with the destination, wherein the crosswind data is determined based on the historical operation data, and wherein the historical operation data indicates one or more historical occurrences of each output state of the pair of output states; and
generate a set of emission probabilities for the specific diversion parameter based on the set of transition probabilities and the crosswind data, wherein each emission probability of the set of emission probabilities indicates a likelihood of output of one of the pair of output states given a state of the plurality of states.

18. The computer system of claim 17, wherein the program instructions further cause the processor set to:
determine a probability distribution over the plurality of states of the second model; and
determine the probability data associated with the specific diversion parameter based on the probability distribution, wherein the probability data indicates a first probability of a first output state of the pair of output states and a second probability of a second output state of the pair of output states.

19. The computer system of claim 18, wherein the first output state is associated with the diversion of the aerial vehicle from the destination, and wherein the second output state is associated with a landing of the aerial vehicle at the destination.

20. A computer-program product for predicting a diversion of an aerial vehicle, the computer-program product comprising:
one or more computer-readable storage media; and
program instructions stored on the one or more computer-readable storage media to perform operations comprising:
retrieving operation data associated with the aerial vehicle, wherein the operation data comprises historical operation data associated with a destination of the aerial vehicle and current operation data is associated with an operation of the aerial vehicle;
applying a first model to the historical operation data;
generating a deviance score for each diversion parameter of a set of diversion parameters based on the application of the first model, wherein each diversion parameter of the set of diversion parameters is associated with the diversion of the aerial vehicle from the destination;
determining a subset of diversion parameters from the set of diversion parameters based on the deviance score;
generating a second model for each diversion parameter of the subset of diversion parameters, wherein the second model is generated based on the current operation data;
determining probability data for each diversion parameter of the subset of diversion parameters based on the second model for each diversion parameter of the subset of diversion parameters, wherein the probability data indicates a probability of the diversion of the aerial vehicle from the destination due to the corresponding diversion parameter of the subset of diversion parameters;
generating diversion data for the diversion of the aerial vehicle from the destination, wherein the diversion data is generated based on the probability data; and
outputting the diversion data.
